(19) United States
(12) Patent Application Publication
(10) Pub. No.: US 2026/0131702 A1
(43) Pub. Date: May 14, 2026

(54) VEHICLE LOWER STRUCTURE

(71) Applicant: TOYOTA JIDOSHA KABUSHIKI KAISHA, Toyota-shi (JP)

(72) Inventor: Takayoshi SHIGIHARA, Toyota-shi (JP)

(73) Assignee: TOYOTA JIDOSHA KABUSHIKI KAISHA, Toyota-shi (JP)

(21) Appl. No.: 19/365,429

(22) Filed: Oct. 22, 2025

(30) Foreign Application Priority Data
Nov. 11, 2024 (JP) 2024-196480

(51) Int. Cl. B60N 2/015; B60R 16/04; B62D 21/03; H01M 50/242; H01M 50/249; H01M 50/293

(52) U.S. Cl. CPC B60N 2/015; B60R 16/04; B62D 21/03; H01M 50/242; H01M 50/249; H01M 50/293; H01M 2220/20

(57) ABSTRACT

The vehicle lower structure includes a pair of side members, a seat cross member, a seat frame, and a cross bulk. The seat cross member has both ends in a vehicle width direction coupled to the pair of side members. The seat frame is attached to the seat cross member via an outer mounting point and an inner mounting point located on an inside of the vehicle width direction with respect to the outer mounting point. The cross bulk is attached to the seat cross member near the inner mounting point with respect to the outer mounting point and locally reinforces the seat cross member.

### CROSS-REFERENCE TO RELATED APPLICATION

This application claims priority to Japanese Patent Application No. 2024-196480 filed on Nov. 11, 2024. The disclosure of the above-identified application, including the specification, drawings, and claims, is incorporated by reference herein in its entirety.

### BACKGROUND

### 1. Technical Field

The present specification discloses a vehicle lower structure including a pair of side members and a seat cross member to which a seat frame is fastened.

### 2. Description of Related Art

In general, two seats that function as a driver seat and a passenger seat are disposed side by side in a vehicle width direction. A frame of such a seat is attached to a skeletal member called a seat cross member. The seat cross member is a skeletal member extending in the vehicle width direction, and both ends of the seat cross member are fastened to a skeletal member called a side member. In general, two seat cross members are disposed at an interval in a vehicle front-rear direction.

Both right and left ends of the seat frame on a front side are attached to a front seat cross member, and both right and left ends of the seat frame on a rear side are attached to a rear seat cross member. Therefore, in general, four corners of the seat frame are attached to the seat cross member via four mounting points.

### SUMMARY

In the related art, rigidity at each of the four mounting points has been significantly different from each other. Specifically, the rigidity at a mounting point located outward of the vehicle width direction has been significantly higher than the rigidity at a

mounting point located inward of the vehicle width direction. As a result, in a case where a load is applied to the vehicle, a vicinity of the mounting point located inward of the vehicle width direction is more likely to be deformed than a vicinity of the mounting point located outward of the vehicle width direction. As a result, there is a problem that the posture of the seat changes and the comfort of the occupant is impaired.

In addition, Japanese Unexamined Patent Application Publication No. 07-081626 (JP 07-081626 A) discloses a structure in which a reinforcing member called a bulkhead is disposed at an end portion in the vehicle width direction of a cross member. According to the technique, the impact force at the time of the side protrusion is effectively absorbed in the bulkhead and the center cross member. However, in the technique of JP 07-081626 A, the rigidity of the cross member at the end portion in the vehicle width direction and the rigidity of the cross member at the center portion in the vehicle width direction are significantly different. Due to the difference in rigidity, the center portion of the cross member changes to a greater extent than the end portion during traveling of the vehicle. As a result, the posture of the seat attached to the cross member is likely to be changed.

Therefore, the present disclosure provides a vehicle lower structure that can more effectively suppress the change in the posture of the seat.

A vehicle lower structure disclosed in the present specification includes a pair of side members, a seat cross member in which both ends in a vehicle width direction are coupled to the side members, respectively, a seat frame attached to the seat cross member via an outer mounting point and an inner mounting point located inward of the outer mounting point in the vehicle width direction, and a cross bulk configured to locally reinforce the seat cross member, the cross bulk being attached to the seat cross member at a position closer to the inner mounting point than to the outer mounting point.

With such a configuration, the rigidity in the vicinity of the inner mounting point is increased, and the difference in rigidity between the inner mounting point and the outer mounting point is reduced. As a result, the tilting of the seat in a roll direction is effectively suppressed.

In addition, the vehicle lower structure disclosed in the present specification may further include a battery pack disposed under the seat cross member, in which the battery pack includes a battery case having an upper case and a lower case, a cell module housed in the battery case, and a resin board provided to fill a gap between an upper surface of the cell module and the upper case, the resin board being adhered to both the cell module and the upper case, and the seat cross member is fixed to the upper case.

By disposing the resin board inside the battery case, the surface rigidity of the upper case that functions as the floor of the vehicle cabin is improved. As a result, the rigidity of the entirety of the seat cross member is improved, and the tilting of the seat in the roll direction is suppressed.

In addition, the vehicle lower structure disclosed in the present specification may further include a front seat cross, and a rear seat cross positioned rearward of the front seat cross, in which each of the front seat cross and the rear seat cross includes the outer mounting point, the inner mounting point, and the cross bulk, and rigidity of the cross bulk of the rear seat cross is higher than rigidity of the cross bulk of the front seat cross.

With such a configuration, a difference in rigidity between the front mounting point and the rear mounting point is reduced, and movement of the seat is more suppressed.

In addition, in the vehicle lower structure described above, the seat cross member may include an upper flange coupled to an upper surface of the side member and a lateral flange coupled to an inner surface of the side member in the vehicle width direction, and a coupling force between the lateral flange and the side member may be smaller than a coupling force between the upper flange and the side member.

By reducing the coupling force of the lateral flange, the rigidity in the vertical direction with respect to the load at the outer mounting point is reduced, and the difference in rigidity between the outer mounting point and the inner mounting point is reduced. As a result, the tilting of the seat in the roll direction is suppressed.

With the structure disclosed in the present specification, the variation in rigidity of the seat cross member is suppressed, so that the change in the seat frame attached to the seat cross member, and thus the change in the posture of the seat can be more effectively suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of main components of a vehicle lower portion;

FIG. 2 is a cross-sectional view taken along line 2-2 in FIG. 1;

FIG. 3 is a B-B cross-sectional view of FIG. 2;

FIG. 4 is a schematic view showing movement of a seat in a case where the seat has a cross bulk;

FIG. 5 is a schematic view showing movement of a seat in a case where the seat does not have a cross bulk; and

FIG. 6 is a perspective view of a portion of the connection between the seat cross member and the side member.

### DETAILED DESCRIPTION OF EMBODIMENTS

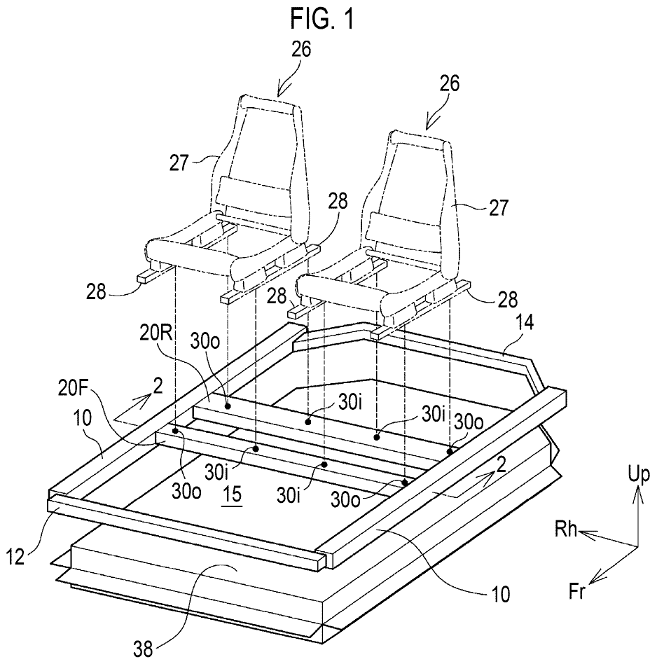

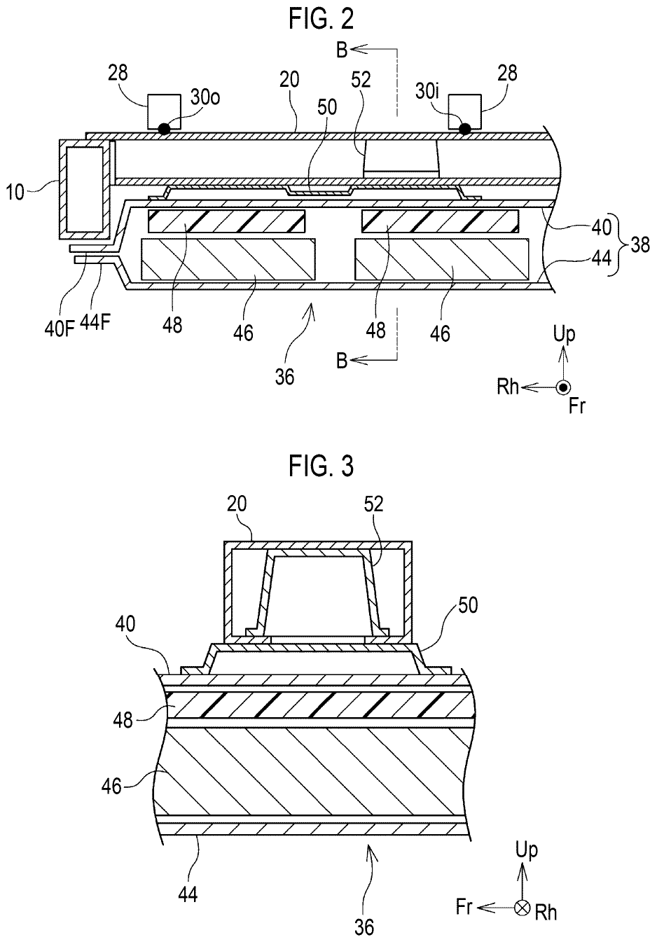

Hereinafter, a vehicle lower structure will be described with reference to the drawings. FIG. 1 is a perspective view of main components of a vehicle lower portion. In addition, FIG. 2 is a cross-sectional view taken along line 2-2 in FIG. 1, and FIG. 3 is a cross-sectional view taken along line B-B in FIG. 2. The vehicle has two seats arranged in a vehicle width direction. In FIG. 1, solely the seat frame 26 that supports each seat is illustrated. A frame of the vehicle is disposed below the seat frame 26. Specifically, the vehicle has a pair of side members 10 and a plurality of cross members 12, 14, 20. The side member 10 is a long skeletal member in the vehicle front-rear direction. Front ends of the pair of side members 10 are connected by a front cross member 12. In addition, the rear ends of the side members 10 are connected by the rear cross member 14. The side members 10, the front cross member 12, and the rear cross member 14 are all hollow members having a substantially rectangular cross section. The side member 10, the front cross member 12, and the rear cross member 14 may be formed by extrusion molding, or may be formed by joining a plurality of panel members. The area surrounded by the side members 10, the front cross member 12, and the rear cross member 14 is a floor surface area 15 that functions as a floor of the vehicle cabin.

A front seat cross member 20F and a rear seat cross member 20R are provided between the front cross member 12 and the rear cross member 14. In addition, in the following, when the front seat cross member 20F and the rear seat cross member 20R are not distinguished, the front seat cross member 20F and the rear seat cross member 20R are referred to as “seat cross member 20”. The front seat cross member 20F and the rear seat cross member 20R are disposed at intervals in the vehicle front-rear direction. Both ends of the front seat cross member 20F in the vehicle width direction are joined to the pair of side members 10. Both ends of the rear seat cross member 20R in the vehicle width direction are also joined to the pair of side members 10. The two seat cross members 20 are also a cross-sectionally substantially rectangular hollow member, and are formed by, for example, extrusion molding or joining a plurality of panel materials.

The seat frame 26 is attached to the seat cross member 20. The seat frame 26 is divided into a body 27 that supports a seat cushion and a seat back, and a seat rail 28 that holds the body 27 to be slidable. The one seat frame 26 has a pair of seat rails 28 disposed at an interval in the vehicle width direction. A front end vicinity of each seat rail 28 is attached to the front seat cross member 20F, and a rear end vicinity of each seat rail 28 is attached to the rear seat cross member 20R.

In the following, a place where the seat rail 28 is attached to the seat cross member 20 is referred to as a “mounting point 30”. Further, viewed from one seat frame 26, the mounting point 30 on the outside in the vehicle width direction is referred to as an “outer mounting point 30o”, and the mounting point 30 on the inside in the vehicle width direction is referred to as an “inner mounting point 30i”. Therefore, one seat frame 26 is attached to the seat cross member 20 through four mounting points 30. The four mounting points 30 are, that is, a front inner mounting point 30i, a front outer mounting point 30o, a rear inner mounting point 30i, and a rear outer mounting point 30o. Here, the attachment form of the seat rail 28 to the seat cross member 20 is not particularly limited. For example, the seat rail 28 may be attached to the seat cross member 20 via a fastening member, such as a bolt, or may be attached to the seat cross member 20 by welding.

A battery pack 36 is disposed below the frames 10, 12, 14, 20. The battery pack 36 stores electric power needed for traveling of the vehicle. As shown in FIG. 2, the battery pack 36 includes a cell module 46, a battery case 38, and a resin board 48. The cell module 46 is a component in which a plurality of battery cells is modularized. The battery cell is a rechargeable secondary battery, and is, for example, a lithium ion secondary battery. The cell module 46 is configured by connecting a plurality of battery cells in series or in parallel. The cell module 46 having one battery pack 36 may be one or a plurality. In the example shown in the drawing, a plurality of cell modules 46 is disposed inside the battery case 38 such that the cell modules 46 are arranged in four columns in the vehicle width direction.

The battery case 38 is a container that houses a plurality of cell modules 46. The battery case 38 is roughly divided into a lower case 44 and an upper case 40. The lower case 44 is substantially box-shaped and is open upward. The cell module 46 is disposed in the internal space of the lower case 44. The upper case 40 is a cover member that covers the upper end opening of the lower case 44 from the upper side. A flange 40F, 44F that protrudes outward in the horizontal direction is provided on the peripheral edge of each of the lower case 44 and the upper case 40. The flange 40F of the upper case 40 is stacked on the flange 44F of the lower case 44 and is adhered to the flange 44F of the lower case 44. The flanges 40F, 44F stacked up and down are screwed and fastened to the bottom surfaces of the side members 10, the front cross member 12, and the rear cross member 14 via fastening members such as bolts.

Here, the outer shape of the battery pack 36 is substantially the same as the outer shape of the floor surface area 15 surrounded by the pair of side members 10, the front cross member 12, and the rear cross member 14. Therefore, in a case where the battery pack 36 is fastened to the side members 10 and the cross members 12, 14, the floor surface area 15 is covered with the battery pack 36. In the present example, the upper case 40 of the battery pack 36 is used as a floor panel of a vehicle cabin.

A resin board 48 is further provided between the cell module 46 and the upper case 40. The resin board 48 is a board member made of resin. The resin board 48 is bonded to both the upper surface of the cell module 46 and the bottom surface of the upper case 40. The resin board 48 is provided to protect the cell module 46 and secure the rigidity of the upper case 40. That is, in the present example, as described above, the upper case 40 is used as a floor panel. Therefore, various loads act on the upper surface of the upper case 40. When such a load is transmitted to the cell module 46, the cell module 46 is deteriorated or damaged. Therefore, the resin board 48 is provided between the cell module 46 and the upper case 40 to improve the surface rigidity of the upper case 40.

Among the upper surfaces of the upper case 40, the patch 50 is joined to a position corresponding to the seat cross member 20. The patch 50 is interposed between the seat cross member 20 and the upper case 40 and is a member for connecting both. Specifically, the patch 50 is a panel member in which solely end portions are joined to the upper case 40 and a center portion is a portion that is raised upward from the end portions. The bottom surface of the seat cross member 20 is screwed or welded to the upper surface of the patch 50, so that the seat cross member 20 is fixed to the upper case 40. Naturally, the seat cross member 20 may be directly fixed to the upper case 40 without using the patch 50.

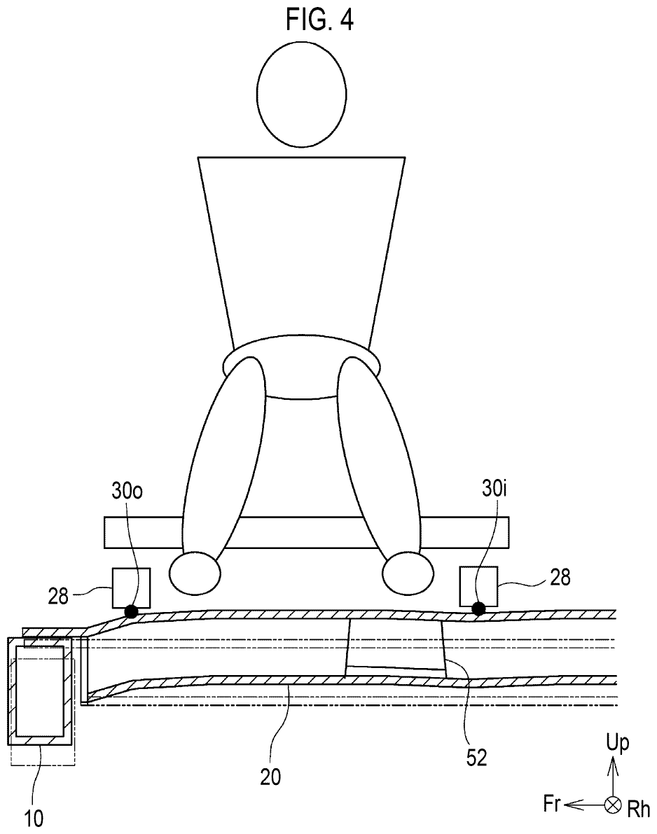

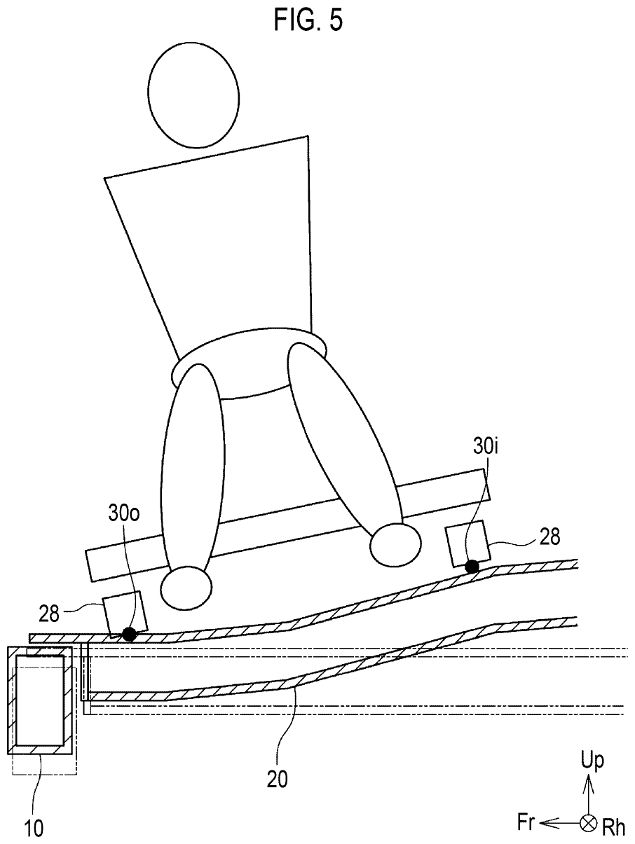

As is clear from FIGS. 2 and 3, the cross bulk 52 is disposed inside the seat cross member 20. The cross bulk 52 is a member that locally reinforces the seat cross member 20. In the present example, the cross bulk 52 has a top surface that is joined to the upper wall of the seat cross member 20 and a pair of legs that extends downward from both ends of the top surface in the vehicle front-rear direction. A lower end of the leg is joined to a lower wall of the seat cross member 20. As shown in FIG. 2, the cross bulk 52 is provided at a position closer to the inner mounting point 30i than the outer mounting point 30o. The reason for providing the cross bulk 52 will be described with reference to FIGS. 4 and 5.

FIG. 5 is a schematic view showing movement of the seat in a case where the cross bulk 52 is not provided. When the vehicle travels, the vibration due to the unevenness of the road surface is transmitted to the side member 10, and the side member 10 vibrates in the vertical direction. In this case, when the cross bulk 52 is not present, the vicinity of the inner mounting point 30i is deformed more largely than the vicinity of the outer mounting point 30o. This is because the rigidity of the vicinity of the inner mounting point 30i is lower than the rigidity of the vicinity of the outer mounting point 30o. That is, the outer mounting point 30o is closer to the connection point with the side member 10 than the inner mounting point 30i, and the vicinity of the outer mounting point 30o is reinforced in strength by the side member 10. Therefore, in a case where the cross bulk 52 is not provided, the rigidity is significantly different between the vicinity of the inner mounting point 30i and the vicinity of the outer mounting point 30o. As a result, in a case where the side member 10 vibrates, the vicinity of the inner mounting point 30i of the seat cross member 20 is deformed more than the vicinity of the outer mounting point 30o.

When the amount of deformation at the inner mounting point 30i and the amount of deformation at the outer mounting point 30o are significantly different from each other, as shown by the solid line in FIG. 5, the seat frame 26 attached to the seat cross member 20, and thus the occupant seated on the seat, swings in the roll direction. As a result, the comfort of the occupant is significantly impaired.

On the other hand, in the present example, as described above, the cross bulk 52 is provided around the inner mounting point 30i such that the rigidity of the inner mounting point 30i is substantially the same as the rigidity of the outer mounting point 30o. As a result, in a case where the vibration is input to the side member 10, the amount of deformation around the inner mounting point 30i and the amount of deformation around the outer mounting point 30o can be substantially equal to each other. As a result, as shown by the solid line in FIG. 4, the seat frame 26, and thus the roll-direction shake of the occupant can be effectively suppressed. As a result, the comfort of the occupant can be maintained at a high level.

In general, a larger load is likely to act on the rear seat cross member 20R than on the front seat cross member 20F. This is because the load of the buttocks of the occupant is easily transmitted to the rear seat cross member 20R. Therefore, in a case where the cross bulk 52 is not provided, the vicinity of the inner mounting point 30i of the rear seat cross member 20R is more likely to be deformed than the vicinity of the inner mounting point 30i of the front seat cross member 20F. In order to suppress the difference in the amount of deformation, the rigidity of the cross bulk 52 attached to the rear seat cross member 20R may be set to be higher than the rigidity of the cross bulk 52 attached to the front seat cross member 20F. For example, the plate thickness or width of the rear cross bulk 52 may be made larger than the plate thickness or width of the front cross bulk 52. In addition, as another aspect, a larger number of cross bulks 52 may be disposed on the rear seat cross member 20R than on the front seat cross member 20F. For example, the cross bulk 52 may be disposed solely under the inner mounting point 30i in the front seat cross member 20F, and the cross bulk 52 may be disposed on both sides in the vehicle width direction with the inner mounting point 30i interposed in the rear seat cross member 20R. In any case, by using the cross bulk 52 to suppress the variation in rigidity at the four mounting points 30, the inclination of the seat frame 26, and thus the inclination of the posture of the occupant, can be suppressed, and the comfort of the occupant can be improved.

Further, in the present example, the battery pack 36 is disposed below the seat cross member 20, and the seat cross member 20 is fixed to the upper case 40. Further, a resin board 48 is disposed between the upper case 40 and the cell module 46 to improve the surface rigidity of the upper case 40. As a result, the rigidity of the seat cross member 20 is reinforced by the upper case 40 and the resin board 48. As a result, the local deformation of the seat cross member 20 is effectively suppressed. As a result, the swinging of the seat frame 26, and thus the inclination of the posture of the occupant can be more effectively suppressed.

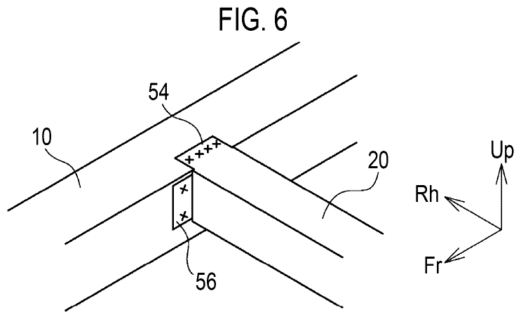

In the description so far, the rigidity around the inner mounting point 30i is increased by using the cross bulk 52. However, in addition to such a configuration, the rigidity around the outer mounting point 30o may be reduced to suppress the variation in rigidity. For example, the coupling force between the seat cross member 20 and the side member 10 may be reduced to reduce the rigidity around the outer mounting point 30o. FIG. 6 is a perspective view of a portion of the connection between the seat cross member 20 and the side member 10. The cross mark in FIG. 6 indicates a welding point. As shown in FIG. 6, the seat cross member 20 has an upper flange 54 that is overlapped with the upper surface of the side member 10 and is joined to the side member 10, and a lateral flange 56 that is overlapped with the inner surface of the side member 10 in the vehicle width direction and is joined to the side member 10. Normally, the upper flange 54 is likely to receive a load in the front-rear direction, and the lateral flange 56 is likely to receive a load in the vertical direction.

In the example of FIG. 6, the coupling force between the lateral flange 56 and the side member 10 is smaller than the coupling force between the upper flange 54 and the side member 10. Specifically, the number of welding points between the side member 10 and the lateral flange 56 (two in the illustrated example) is smaller than the number of welding points between the side member 10 and the upper flange 54 (four in the illustrated example). As a result, the coupling force between the seat cross member 20 and the side member 10 is reduced, and the seat cross member 20 is easily moved in the vertical direction. In other words, the rigidity of the end portion of the seat cross member 20, that is, the rigidity around the outer mounting point 30o is reduced. As a result, the variation in rigidity of the seat cross member 20 is suppressed, local deformation of the seat cross member 20, and thus, the inclination of the posture of the occupant is effectively suppressed.

As described above, four mounting points 30 are set in one seat frame 26. Then, the variation in rigidity at each of the four mounting points 30 is suppressed, whereby the local deformation of the seat cross member 20, and thus the inclination of the posture of the occupant seated on the seat are effectively suppressed. As a result, the comfort of the occupant is improved. The configurations described above are merely examples, and other configurations may be appropriately changed as long as the configurations of claim 1 are provided. For example, in the above description, the upper case 40 of the battery pack 36 is used as a floor panel. However, a panel material that functions as a floor panel may be separately provided in addition to the battery pack 36. In this case, the panel material that functions as the floor panel is joined to the side member 10, the front cross member 12, and the rear cross member 14. In addition, the seat cross member 20 is fixed to the floor panel, not the upper case 40. Further, the vehicle may have a configuration without the battery pack 36. Therefore, the vehicle may be an engine vehicle that does not have a motor and travels by power of an engine. In addition, the shape or the number of the cross bulk 52 may be appropriately changed as long as the cross bulk 52 is disposed closer to the inner mounting point 30i than the outer mounting point 30o. In addition, the cross bulk 52 may be attached to the outside of the seat cross member 20, not limited to the inside of the seat cross member 20, as long as the cross bulk 52 locally reinforces the seat cross member 20.

What is claimed is:

1. A vehicle lower structure comprising:
a pair of side members;
a seat cross member in which both ends in a vehicle width direction are coupled to the side members, respectively;
a seat frame attached to the seat cross member via an outer mounting point and an inner mounting point located inward of the outer mounting point in the vehicle width direction; and
a cross bulk configured to locally reinforce the seat cross member, the cross bulk being attached to the seat cross member at a position closer to the inner mounting point than to the outer mounting point.

2. The vehicle lower structure according to claim 1, further comprising a battery pack disposed under the seat cross member, wherein:
the battery pack includes
a battery case having an upper case and a lower case,
a cell module housed in the battery case, and
a resin board provided to fill a gap between an upper surface of the cell module and the upper case, the resin board being adhered to both the cell module and the upper case; and
the seat cross member is fixed to the upper case.

3. The vehicle lower structure according to claim 1, further comprising:
a front seat cross; and
a rear seat cross positioned rearward of the front seat cross, wherein:
each of the front seat cross and the rear seat cross includes the outer mounting point, the inner mounting point, and the cross bulk; and
rigidity of the cross bulk of the rear seat cross is higher than rigidity of the cross bulk of the front seat cross.

4. The vehicle lower structure according to claim 1, wherein:
the seat cross member includes an upper flange coupled to an upper surface of the side member and a lateral flange coupled to an inner surface of the side member in the vehicle width direction; and
a coupling force between the lateral flange and the side member is smaller than a coupling force between the upper flange and the side member.
